(19) United States
(12) Patent Application Publication
(10) Pub. No.: US 2013/0275946 A1
(43) Pub. Date: Oct. 17, 2013

(54) SYSTEMS AND METHODS FOR TEST DEVELOPMENT PROCESS AUTOMATION FOR A TEST HARNESS

(71) Applicants: Alexandr Pustovit, Prague (CZ); Mikhail Davidov, Saint-Petersburg (RU)

(72) Inventors: Alexandr Pustovit, Prague (CZ); Mikhail Davidov, Saint-Petersburg (RU)

(73) Assignee: Oracle International Corporation, Redwood City, CA (US)

(21) Appl. No.: 13/448,093

(22) Filed: Apr. 16, 2012

(51) Int. Cl. G06F 11/36

(52) U.S. Cl. 717/124

(57) ABSTRACT

Systems and methods for automatic generation of one or more test cases to be used in conjunction with a test harness for testing software applications are disclosed. A description including one or more steps to be included in a test case is received by an processing device. The processing device parses the description to generate one or more test cases, which are subsequently used as input for a test harness. The test harness is executed using the test cases as input to test one or more portions of a software application.

### TECHNICAL FIELD

Aspects of the present disclosure relate to software testing, and in particular, automatic software testing.

### BACKGROUND

Software testing, which generally describes the process of determining whether or not a software application is operating correctly, is a critical component of the software development process. Typically, software testing methods require the technical expertise of one or more highly-skilled software developers. For example, a program developer may design a software test to be executed on a software application. Alternatively, the program developer may manually test the software application by interacting with the tested software application during execution to determine whether the software is operating as desired. All of such software testing methods are expensive and time-consuming.

A particular type of software testing includes the use of a test harness, which includes a test engine and a collection of tests that may be executed by the test engine to verify that a software application is behaving according to its design specifications. To run the test harness, a skilled software developer generally develops complex code that implements the various tests that are executed by the test engine, which again is labor-intensive and time-consuming. It is with these observations in mind, among others, that various aspects of the present disclosure were developed.

### SUMMARY

Aspects of the present disclosure include methods for test suite generation. The method includes receiving test case description data defining instructions for testing a software application at a processor. The method also includes parsing, at the at least one processor, the test case description data to generate at least one test suite conforming to a particular format of a test harness. The method includes extracting, at the at least one processor, at least one image of a plurality of images from the test case description data to associate with the test suite, the at least one image identifying a portion of the software application to be tested. The method further includes executing, at the at least one processor, the test harness to test the software application, using the at least one test suite as input to the test harness.

According to one aspect, a system for test suite generation. The system includes a database and at least one processor. The system further includes a test generation application comprising modules executable by the at least one processor. The test generation application modules include a test description module to receive test case description data defining instructions for testing a software application. The test description module also extracts at least one image of a plurality of images from the test case description data to associate with the test suite, the at least one image identifying a portion of the software application to be tested. The test generation application modules also include a test case generation module to parse the test description data to generate at least one test suite conforming to a particular format of a test harness and an execution module to test the software application, using the at least one test suite as input to the test harness.

According to another aspect, a non-transitory computer-readable medium for test suite generation is disclosed. The non-transitory computer-readable medium is encoded with a test generation application comprising modules executable by a processor. The modules include a test description module to receive test case description data defining instructions for testing a software application. The test description module also extracts at least one image of a plurality of images from the test case description data to associate with the test suite, the at least one image identifying a portion of the software application to be tested. The modules further include a test case generation module to parse the test description data to generate at least one test suite conforming to a particular format of a test harness. The modules include an execution module to execute a test harness to test the software application, using the at least one test suite as input to the test harness.

### BRIEF DESCRIPTION OF THE DRAWINGS

The foregoing and other objects, features, and advantages of the present disclosure set forth herein will be apparent from the following description of exemplary embodiments of those inventive concepts, as illustrated in the accompanying drawings. It should be noted that the drawings are not necessarily to scale; however, the emphasis instead is being placed on illustrating the principles of the inventive concepts. Also, in the drawings the like reference characters refer to the same parts throughout the different views. The drawings depict only exemplary embodiments of the present disclosure and, therefore, are not to be considered limiting in scope.

FIG. 1 is a block diagram illustrating a computing environment, according to aspects of the present disclosure.

FIG. 2 is a block diagram illustrating a processing device, according to aspects of the present disclosure.

FIG. 3 is a block diagram illustrating a test harness, according to aspects of the present disclosure.

FIG. 4 is a block diagram illustrating a test case description data input form, according to aspects of the present disclosure.

FIGS. 5A-5C are block diagrams illustrating test case description data tables, according to aspects of the present disclosure.

FIGS. 6A and 6B are flowcharts illustrating an example processes for automatically generating tests, according to aspects of the present disclosure.

### DETAILED DESCRIPTION

The present disclosure describes systems and corresponding methods for automatic software testing, and in particular, the automatic generation of one or more test cases for testing a particular software application. In various aspects, a description reciting one or more steps and/or procedures of a test case is received by a processing device. Subsequently, the processing device parses and/or otherwise processes the description to generate the one or more test cases in a standardized format. The test cases may be grouped into a test suite and a test harness may be executed using the test suite as input to verify and/or determine whether or not the particular software application being tested is behaving according to its original implementation specifications.

Software testing generally describes the use of software to test other, more complex, software applications. For example, a programmer and/or developer will design testing software that executes on, or in conjunction with, the tested software application under controlled conditions to: 1) verify that the software application behaves as designed; 2) detect any errors within the software application; and 3) provide the results of the testing to programmers, developers, etc. Often, a test harness will be used to facilitate the automatic testing of a complex software application. A test harness generally includes a collection of software and test cases configured to test portions and/or units of a software application. Additionally, the test harness includes a tool, such as a test engine, that automatically executes a portion of the software code using the various test cases and/or test conditions as input. The test harness may monitor the behavior of the portion of the software application being tested, compare the outcome of the testing to predicted results, and provide such an analysis as output. In most cases, a test harness provides functionality for performing test case launching and result reporting. Some test harness environments may also include a graphical user interface and allow for test case scripting.

Generally, a highly-skilled programmer or software developer implements each of the one or more test cases that are executed as a part of the test harness when testing a portion of a software application. Moreover, the programmer and/or developer must have an in depth understanding of the test harness in order to properly integrate the test cases with existing test harness functionalities. For example, a programmer may require extensive knowledge of the test harness to: call functions within the test harness to facilitate the automation of one or more test cases; capture output resulting from executing one or more test cases; and implement functionality to provide the output with an indication as to whether or not each test case that was executed was successful. Finally, any design modifications to the software application being tested by the test harness may require the modification of existing test cases and/or the creation or new test cases. All of such actions may result in expensive, labor-intensive, and time-consuming efforts by skilled programmers and/or developers.

Accordingly, aspects of the present disclosure allow users the ability to quickly generate one or more test cases without extensive understanding of the test harness and with minimal programming skills. Additionally, the test cases may be quickly generated in a standardized reuseable format allowing for easy updating. The one or more test cases may be executed with a test harness to generate and/or provide useful outputs including information relating to the tested software applications environment, execution behaviors, etc.

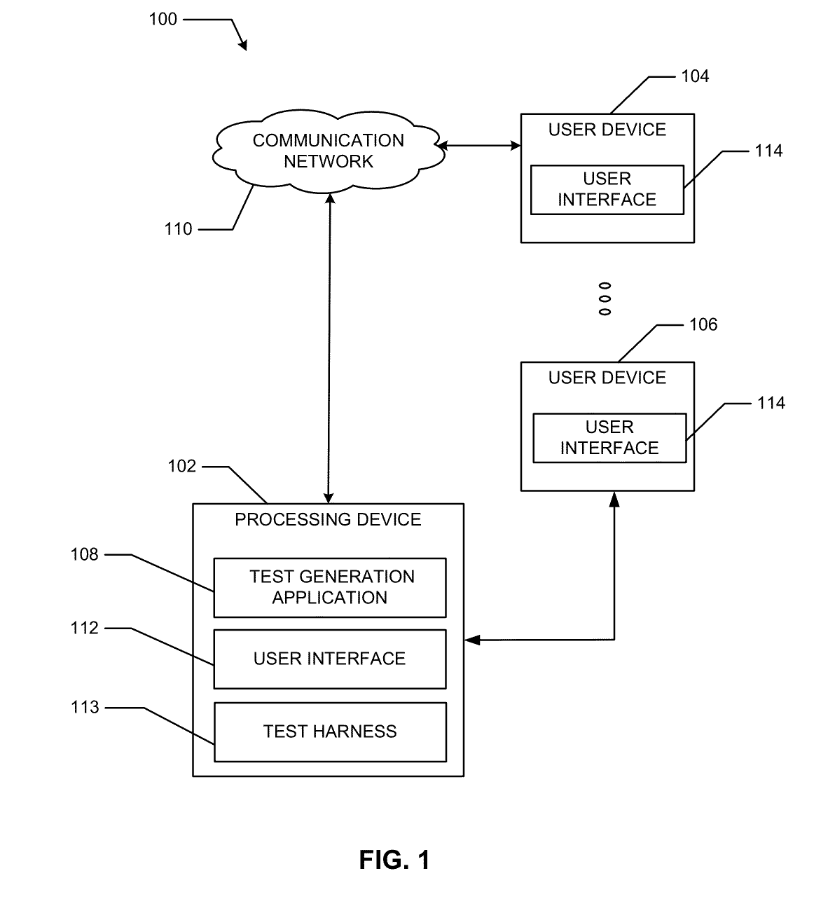

FIG. 1 illustrates an example computing environment 100 that may implement various exemplary embodiments of the present disclosure. A processing device 102 and/or user devices 104-106 may include various hardware and accompanying software computing components that may be configured for implementing and/or generating one or more test cases and performing such test cases on a particular software application. For example, the processing device 102 may execute a test generation application 108 that automatically generates, executes, and monitors the output of the one or more test cases on a test harness 113 to validate whether or not a particular software application being tested is behaving as designed. The test generation application 108 may be located on the processing device 102 and/or on the user devices 104-106, or elsewhere.

The processing device 102 and/or the user devices 104-106 may be a personal computer, work station, server, mobile device, mobile phone, processor, and/or other processing device. Each device may include one or more processors that process software or other machine-readable instructions and may include a memory to store the software or other machine-readable instructions and data. The memory may include volatile and/or non-volatile memory. Additionally, each device may also include a communication system to communicate via a wireline and/or wireless communications, such as through the Internet, an intranet, and Ethernet network, a wireline network, a wireless network, and/or another communication network. The processing device 102 and/or the user devices 104-106 may further include a display (not shown) for viewing data, such as a computer monitor, and an input device (not shown), such as a keyboard or a pointing device (e.g., a mouse, trackball, pen, touch pad, or other device) for entering data and navigating through data, including exams, images, documents, structured data, unstructured data, HTML pages, other web pages, and other data.

According to one aspect, the processing device 102 and/or the remote test device 104 may include a user-interface (UI) 112 and 114 to receive input from a user to generate one or more test cases that may be executed with a test harness 113 for testing a software application. UIs 112 and 114 may include a display (not shown) such as a computer monitor, liquid crystal display, for viewing data and/or input forms, and any combination of input/output devices (not shown), such as a keyboard, or a pointing device (e.g., a mouse, trackball, pen, or touch pad), speaker, and/or any other type of device for receiving input to define a test case and outputting data related to such test cases.

The user devices 104-106 may communicate with the processing device 102 through a communication network 110, which may be the Internet, an intranet, a local area network, a wireless local network, a wide area network, or another communication network, as well as combinations of networks. For example, the user devices 104-106 may communicate with the processing device 102 through a private network to perform automatic testing. In another aspect, the user devices 104-106 may communicate with the processing device 102 directly such as through an Ethernet connection. While aspects of the present disclosure have been described as being performed using multiple devices within a computing environment, such as computing environment 100 shown in FIG. 1, it is contemplated that such aspects may be performed locally, using only a single device, such as the processing device 102 and in such cases the user device is integrated to or otherwise in direct connection with the processor 102.

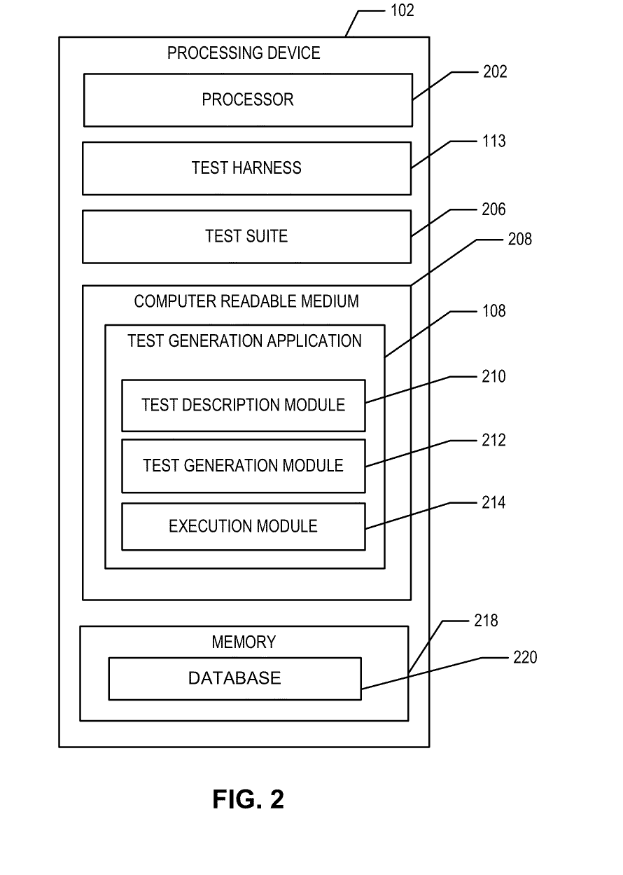

FIG. 2 is an example block diagram illustrating the various hardware and/or software components of the processing device 102 according to one exemplary embodiment of the present disclosure. The processing device 102 may include a processor 202 that may be used to execute the test generation application 108 that automatically generates one or more test cases in a standardized format, which may be used to test a software application. The processor 202 may include memory and/or be in communication with a memory 218, which may include volatile and/or non-volatile memory. The processor 202 may also include various other computing components.

The processing device 102 may also include a database 220. The database 220 may be a general repository of data including test data, test case data, test suite data and/or any other data relating to the automatic generation of test cases, test suites, etc., that may be used in conjunction with the test harness 113 to test the behaviors of a particular software application. The database 220 may include memory and one or more processors or processing systems to receive, process, query and transmit communications and store and retrieve such data. In another aspect, the database 220 may be a database server. According to one aspect, the database 220 may contain one or more test case templates as will be described below.

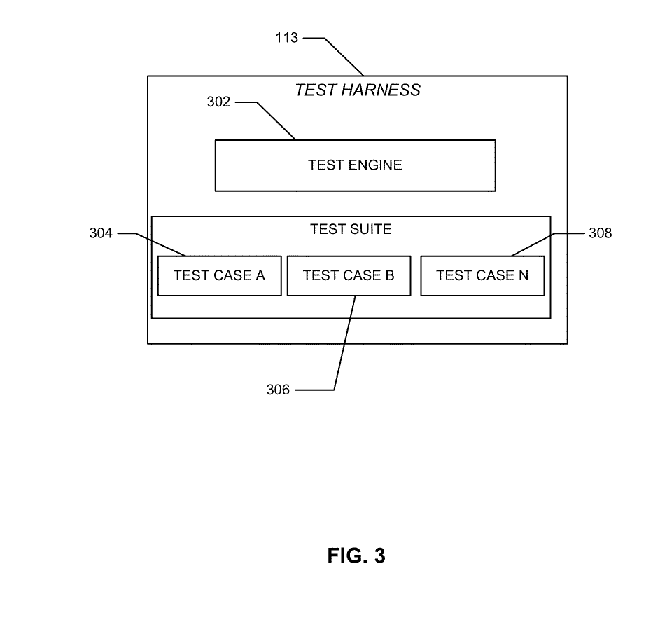

The processing device 102 may include the test harness 113. The test harness 113 may execute a test suite 206, which may be a collection of one or more test cases that are intended to be used to test a software application to verify that the software application is behaving according to the application's initial implementation specifications. In particular, the test harness 113 may execute a portion of the particular software application being tested using one or more test cases. Each test case may include instructions and/or steps describing how to perform a test. After each test case is performed, a result of a pass, fail, error, or other type of output may be obtained that corresponds to the executed test case. For example, referring to FIG. 3, the test harness 113 may be run on test case A 304 and return a result of failed. As another example, the test harness 113 may be run on test case B 302 and return a result of passed. The test suite 206 may have any number of test cases as shown by test case N 308. Once all of the test cases within the test suite 206 have been run, an overall result of the test suite may be provided. In one aspect, the results may be in the form of a list and/or table illustrating each test case and its result may be provided as output.

For example, if test case A 304 and test case B 306 were run as in the above examples, the test suite 206 may provide a table illustrating that test case A 304 failed and test case B 304 passed. While the test harness 113 is depicted in FIG. 2 as being a component of the processing device 102, the test harness 113 may be located external to the test system 102. For example, it is contemplated that the test harness 113 may be located and executed on the user devices 104-106, or other device.

In one exemplary implementation, the test harness 113 may be a readily available test harness such as JT harness, the open source version of Oracle's JavaTest™ Harness commercial product (“JT harness”). The JT harness is based on Oracle's JavaTest harness and is a general purpose, fully-featured, flexible, and configurable test harness that may be used to perform most types of software application unit testing. The JT harness may be used to run tests on all of the Java platforms, such as the Java® Card platform, the Java® Standard Edition (“Java SE”) Platform, the Java® Micro Edition (Java ME) Platform. Additionally, the JT harness allows users to create test suites that are self-contained products, which customers may configure and run. The JT harness may be used to configure, sequence, and run complex test suites that consist of one or more test cases. Alternatively, the test harness 113 may be the test harness of a Java® Device Test Suite. The Java Device Test Suite represents an extensible set of test packs and a test execution harness that may be used to assess the quality of any device that implements a compatible combination of the Java ME technologies. In yet another example, the test harness may be a light-weight JT harness. While various Java Test harness technologies have been described according to aspects of the present disclosure, it is contemplated that any type of test harness may be used.

Returning to FIG. 2, the processing device 102 may include a computer readable media (“CRM”) 208, which may include computer storage media, communication media, and/or another available computer readable media medium that can be accessed by the processor 202. For example, CRM 208 may include non-transient computer storage media and communication media. By way of example and not limitation, computer storage media includes memory, volatile media, nonvolatile media, removable media, and/or non-removable media implemented in a method or technology for storage of information, such as machine/computer readable/executable instructions, data structures, program modules, or other data. Communication media includes machine/computer readable/executable instructions, data structures, program modules, or other data. The CRM 208 may store executable instructions to implement the test generation application 108. Generally, program modules include routines, programs, instructions, objects, components, data structures, etc., that perform particular tasks or implement particular abstract data types.

According to one aspect, the test generation application 108 may include a test description module 210 that receives test case description data including instructions, parameters, and/or characteristics, which specify one or more actions, processes, or steps that should be taken to perform a particular test, which may be used to test a software application. The test case description data may be a file and may include text strings, images, pictures, screen shots, etc. For example, the test case description data may include text identifying a specific functionality and/or component of a software application that should be tested. In another example, the test case description data may include step-by-step instructions for executing various functions and/or components of the software application being tested during testing. In yet another example, the test case description data may include one or more screen shots of the application being tested and corresponding text describing the actions that a user should take in order to properly test a graphical user interface element and its associated function of the software application being tested.

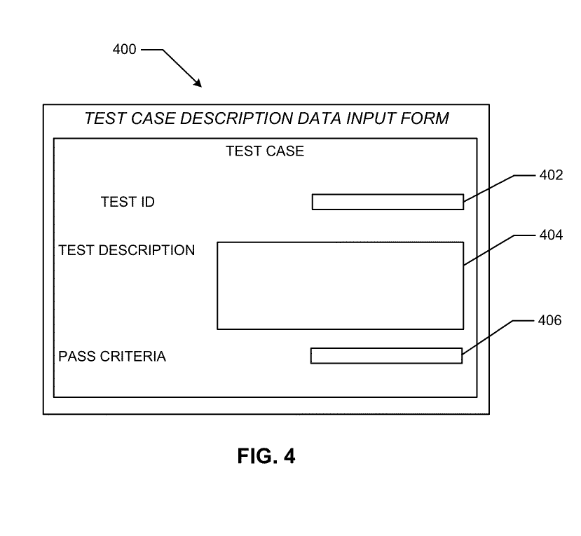

Referring to FIG. 4, the test description module 210 may transmit instructions that may be processed and/or executed to display one or more input forms 400 on the user devices 104-106 to receive a test case description. Subsequently, a user, such as a tester, may interact with the one or more input forms to easily enter test case description data describing one or more test cases and/or test scenarios. The description may be in human readable form, incorporating rich formatting, such as different font styles, lists, etc. Alternatively, the test description module 210 may receive and/or retrieve a test case description data file, containing test case description data, such as one or more test cases, that was previously created by a user and saved or otherwise stored in the database 220. In one exemplary implementation, the test case description data file may be an OpenOffice Document (odt) file containing the instructions of a particular test case that should be executed and may conform to the Institute of Electrical and Electronics Engineers (“IEEE”) standards for quality documentation.

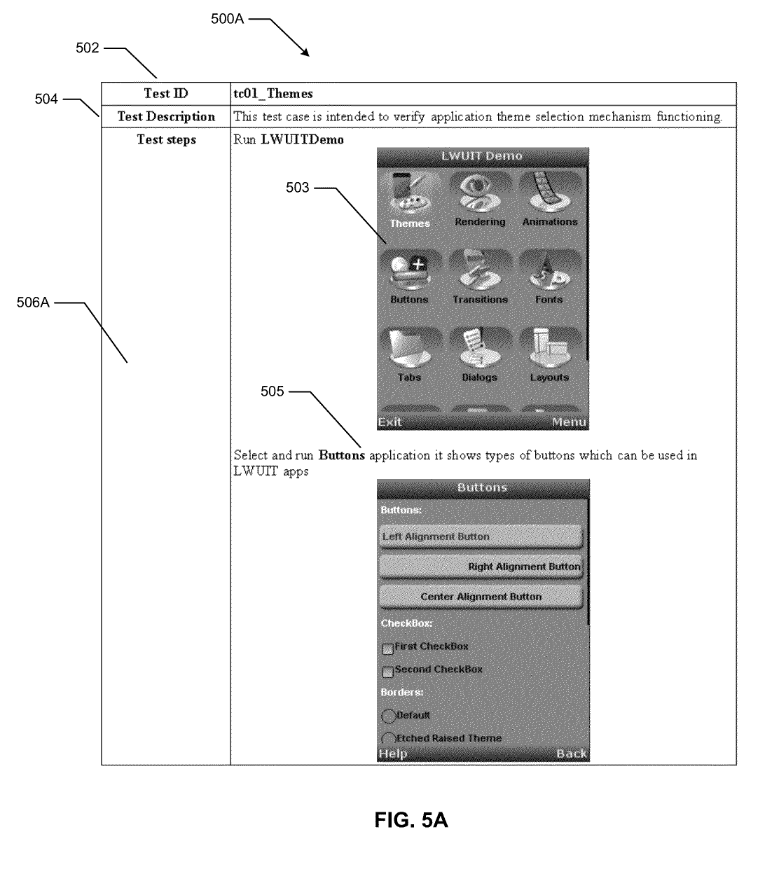

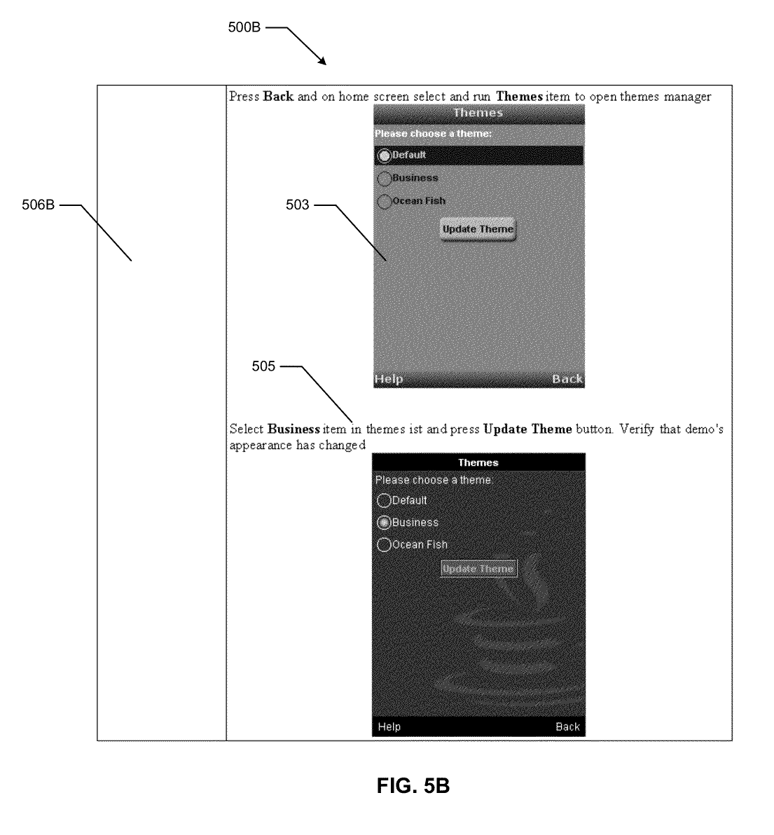

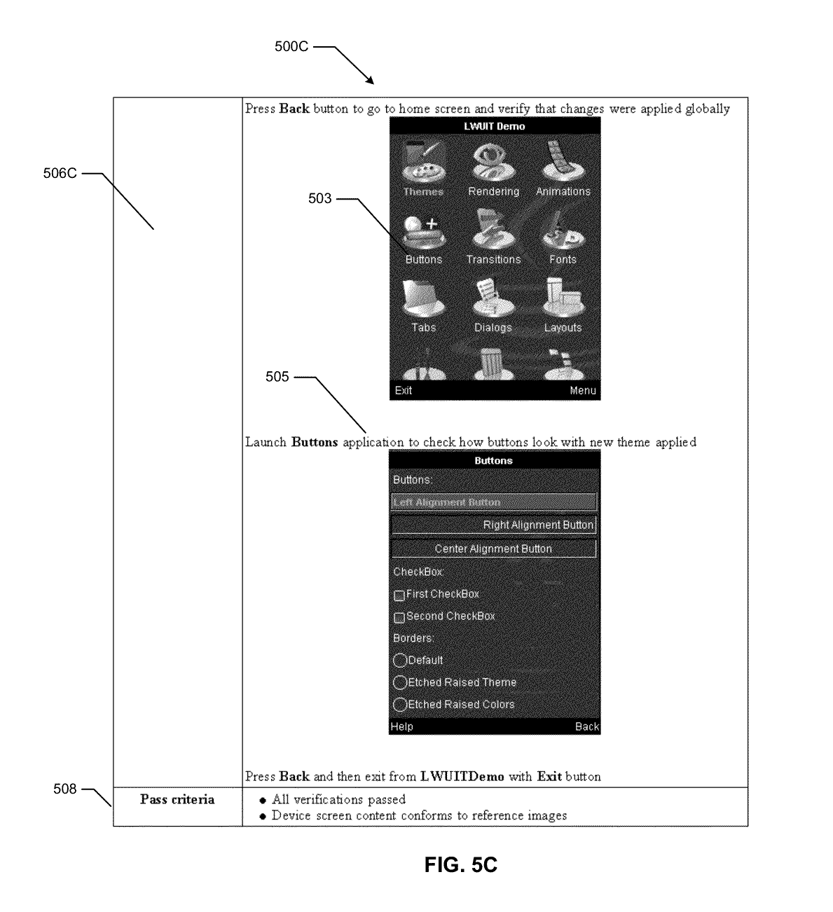

The test case description data file may include a pre-formatted table including one or more rows, or implicitly structured data items. FIGS. 5A-5C illustrates a representative example of a test case table according to aspects of the present disclosure. As shown, the table includes a “TestID” row 502 that uniquely identifies the name of a particular test case, such as by a unique name or number. The table includes a “Test Description” row 504 that defines a general description of the test case and its associated testing purpose. The table also includes one or more “test step” rows 506A-506C, wherein each test step defines instructions, which may be a single instruction, for testing the portion of the particular software application. As illustrated, the “test step” rows 506A-506C may include images and/or associated text that describe various instructions for testing the application. For example, image 503 is an example screen shot of an Lightweight User Interface Toolkit (LWUIT) application and text 505 is an instruction describing how a user should test the screen shot.

The table may include a “pass criteria” row 508, which describes how a particular application being tested must behave in order to pass the associated test. For example, as illustrated in FIG. 5C, pass criteria 508 indicates that the LWUIT application must pass all verifications and the screen content must conform to reference images in order to pass the test. Other rows and/or columns, etc., may be included in the table. While FIGS. 5A-5C only illustrate one particular test case, it is contemplated that the table may contain test case description data for more than one test case; many different tests and/or test cases; a plurality of test cases; etc.

After receiving test case description data, the test description module 210 may automatically initiate a test generation module 212 that analyzes, parses, and/or otherwise processes the test case description data received by the test description module 210 to generate one or more test suites. Initially, the test description module 210 may process the test case description data and reformat the test case description data into a standardized re-usable format. In one exemplary implementation, the test case description data may be reformatted and/or otherwise saved into an Extensible Markup Language (XML) structure or format. Typically, XML documents form a tree structure that starts at a “root/parent” element and branches to one or more “child” elements. Thus, the test case description data may be defined in such an XML format as XML data.

The test description module 210 may create one or more text styles used for text formatting. Each piece of text within a text case description data file may include unique formatting such as bold, italic, size, or any other type of text formatting. The various text formats may be organized as a numbered list in a file and/or other output. Subsequently, the formats may be used to format text in generated test cases.

The test description module 210 may parse and/or otherwise process the test case description data to obtain information regarding any images that may be present within a particular test case. Subsequently, the images may be extracted from the test case description data and saved in the database 220. For example, the images may be saved in a test suite resources folder in the database 220, which may subsequently be associated with, accessed by, added to, processed by and/or otherwise incorporated into any generated test suites, and/or test harnesses, etc.

The test generation module 212 may parse and/or process the test case description data file to identify one or more tables containing one or more test cases scenarios. A test scenario generally describes an outline or model of an expected test case. In particular, the test generation module 212 may parse the test case description data file to identify a section name for the table. A section name represents a logical subsection of the test case description data file that may be used for separation of logically independent test cases. For example, the test case description file may include a section name “installer” followed by test cases related to the installation of software. Subsequently, in the same test description data file there may be a section name of “launch” followed by test cases related to software launching. The section name may be included in the test case description file as a table having one row and one column.

If a table section name exists, the test generation module 212 creates a Java® file and saves and closes the Java® file and/or opens an existing Java® when a handler exists. Subsequently, a new folder structure may be created and a new file saved. If a table section name cannot be identified, the test generation module 212 again determines whether any of the identified tables includes a scenario. When a scenario exists, test case data, such as: test id, test description, test steps, and pass criteria, is extracted from the identified table and saved as data in a java file. When no test scenario exists, a java file is saved and closed. In one exemplary embodiment, one or more of the java files may be grouped into Java Archive files (“JAR”). A JAR file is an archive file format typically used to aggregate many Java class files and associated metadata and resources (text, images and so on) into one file to distribute application software or libraries on the Java platform.

Once one or more test cases have been generated (e.g. one or more Java® files), the test generation module 212 may use the one or more test cases to generate one or more test suites, or test packs. Stated differently, the test generation module 212 may incorporate one or more related test cases and/or tests identified from the test case description data into a larger group of tests, or a test suite (also referred to as a test pack). The integration process used to combine the one or more tests into a test suite may depend on the specifications of the particular test harness in use. In one possible implementation, the test generation module 212 may utilize various resources within a Java® ME TCK framework to create and/or otherwise generate Java® test suites. Java® ME TCK test suites use the JT harness for test execution and test suite management. Thus, the test cases, or Java® files, may be interpreted by the JT harness as a standard test suite. In another implementation, the test generation module 212 may utilize various resources within a Java® Device Test Framework to create and/or otherwise generate Java® test suites. The Java® Device Test Framework is designed to create, configure, sequence and run multiple test suites/test packs that exercise Java technology installed in test devices, such as mobile phones, and may be used to create test suites/test packs compatible with the Java® Device Test Suite.

The test suites may contain rich formatting for the test instructions within each particular test case, any associated reference images, and test applications, based on the formats generated by the test description module 210. Additionally, the test generation module 212 may automatically add and/or otherwise bundle the software application being tested with the corresponding test suite that has been generated to test the software application.

Once one or more test cases, test suites/test packs have been generated, the test generation module 212 provides and/or otherwise communicates the one or more test cases and/or test suites to an execution module 214. The execution module 214 may initiate the test harness 113, which executes a portion of a particular software application being tested and runs the one or more test suites on the software application. For example, in one possible implementation, the execution module 214 may execute a JT harness on a processing device. During execution, the JT harness may display a graphical user interface, such as a test case window. The JT harness may execute on one or more test cases and/or test suites generated by the test generation module 212 and render test case description data for display on the JT harness graphical user interface. In one aspect, the JT harness graphical user interface may include one or more forms for receiving input from a user, such as a text field for storing note related to testing. Alternatively, a test harness of the Java® Device Test Suite may be used to execute the test suite/test packs generated by the generation module 212 and may execute in a similar manner as the JT harness.

During and/or subsequent to the execution of the portion of the particular software application, one or more outputs describing whether a particular software application is executing as originally defined by its initial specification descriptions may be provided. The output data may include pass/fail determinations, error conditions, etc. For example, the execution module 214 may provide a report describing all of the different tests that were executed on the particular software application. Additionally, the report may indicate the number of tests that passed and failed and corresponding defect information for the failed tests. The report may provide information describing how to run each particular test within the test suite. The report may provide configuration data describing how to configure each test within the test suite. Other output data may also be included. Ultimately, the execution of the generated test suites/test packs with an associated test harness can be used to assess the quality of any device that implements a compatible Java technologies, such as Java ME technologies.

In particular, output from executing test suites generated by the generation module 212 using the Java® ME TCK Framework standards that are subsequently executed by the JT harness may verify that an implementation of a Java technology conforms both to the applicable Java platform specifications and to the corresponding reference implementations—the end result is a Java technology that is certified as compatible. Additionally, output received from executing test suites generated by the generation module 212 using the Java® Test Device Framework standards that are subsequently executed by the test harness of the Java® Device Test Suite may verify that an implementation of a Java technology conforms both to the applicable Java platform specifications and to the corresponding reference implementations.

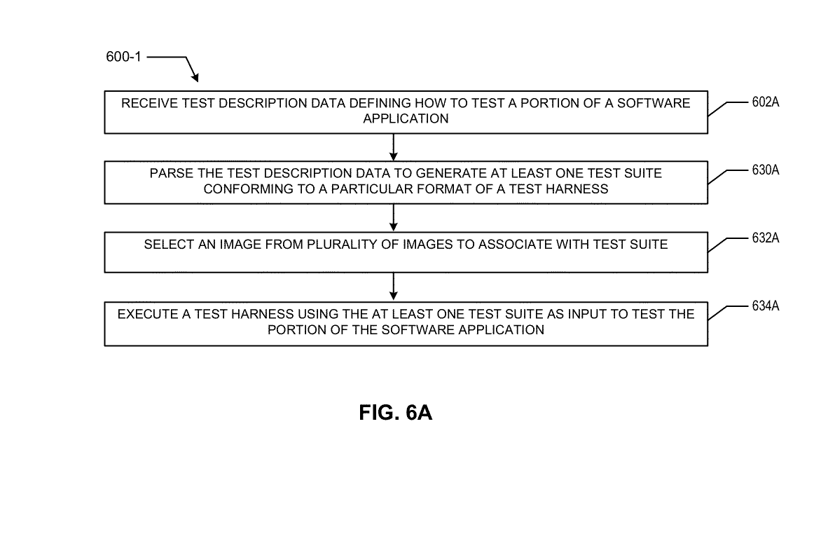

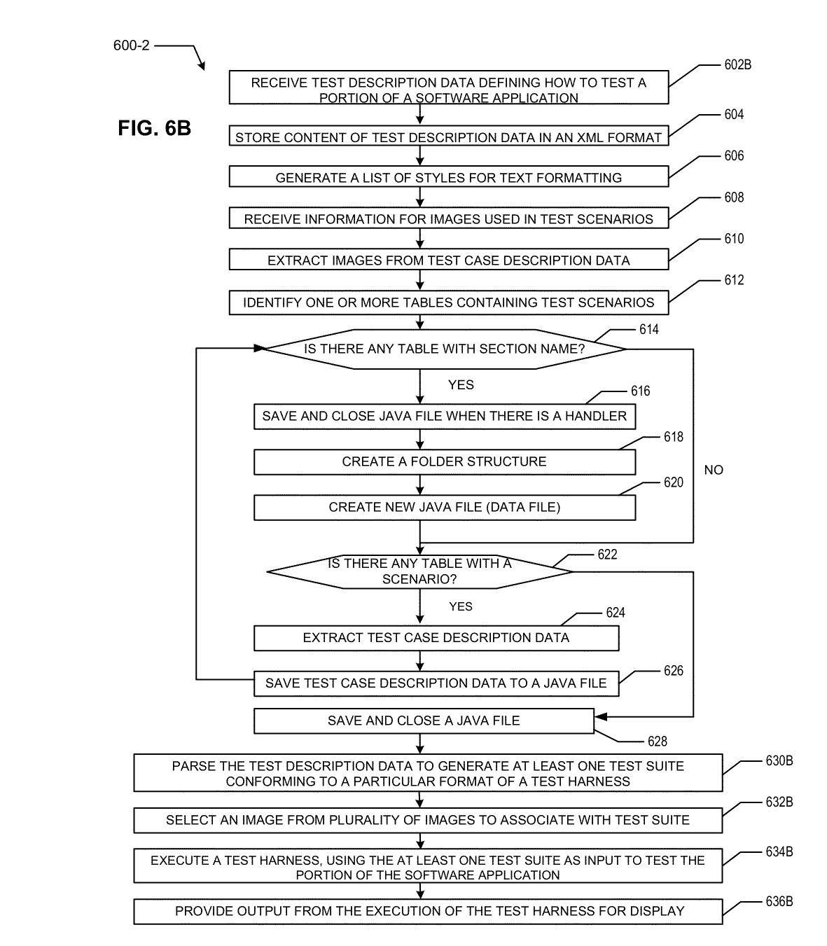

FIGS. 6A and 6B depicts example embodiments of a method and/or process 600-1 and 600-2 for generating one or more test suites for testing a portion of a software application. Process 600-1 and 600-2 may be executed by at least one processor encoded with, or executing instructions of, a test generation application 108. Initially, processes 600-1 and 600-2 involve the general operation of 602A and 602B, where test case description data defining how to test a portion of a software application is received. For example, a test case description .odt file including a one or more tables describing one or more steps for testing a graphical user interface of a software application is received by the test generation application 108 on the processing device 102.

Referring to FIG. 6B and process 600-2, at 604, the content of the test case description data may be reformatted into an XML format. For example the .odt test case description file may be converted and/or otherwise saved in an XML format as XML data. At 608, a list of styles is generated that may be used for text formatting.

At 608, information related to one or more images within the test case description data is retrieved and the images are extracted at 610. For example, information related to any images within the .odt test case description file is retrieved and the associated images are extracted and stored in the database 220. At 612, one or more tables containing test scenarios are identified from the test case description data. For example, the .odt test case description data file may be parsed to identify one or more tables. At 614, it is determined whether a table with a section name exists within the test case description data. For example, the one or more tables identified within the .odt test case description data file may processed to identify a section name. When a section name exists, a java file is saved and closed when a java handler exists at 616. Subsequently, a folder structure is created at 618 and a new java file is generated at 620. When a section name does not exist, the method continues at step 622.

At 622, the one or more tables identified from the test case description data are processed to determine whether any table scenarios exist. When a table scenario exists, test case description data such as test ID, test description, test steps, and pass criteria is extracted at 624 and saved as a Java® file at 626, and the process returns to step 614 to determine whether any more test case description data may be identified. When no table scenario exists, a Java® file is saved and closed at 628.

Referring now to both FIGS. 6A and 6B, at 630A and 630B, the test case description data is parsed to generate at least one test suite conforming to a particular format of a test harness. For example, the test case description file may be parsed and converted into a format conforming with a JavaTest harness. At 632A and 632B, an image identifying a portion of the software application to be tested is selected and/or extracted and associated with the test suite. For example, a particular screen shot of the application being tested is extracted from the test description data file. The test harness is executed to test the portion of the software application using the at least one test suite as input at 634A and 634B. Referring to FIG. 6B, output from the execution of the test harness is provided for display at 636B. For example, a report describing pass/fail determinations and error conditions of each of the test cases within the at least one test suite may be provided for display at the user devices 102-104.

Thus, in accordance with various aspects of the present disclosure and the various exemplary embodiments of the present invention described above, an processing device 102 may automatically generate one or more test suites conforming to a particular format of a particular test harness. Subsequently, the test suites may be executed in conjunction with the test harness and output of the tests may be monitored to determine whether or not the software application is behaving during execution as designed.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various exemplary embodiments, it will be understood that these embodiments are illustrative and that the scope of the disclosure is not limited to them. Many variations, modifications, additions, and improvements are possible. More generally, embodiments in accordance with the present disclosure have been described in the context of exemplary implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for test suite generation comprising:
receiving, at at least one processor, test case description data defining instructions for testing a software application;
parsing, at the at least one processor, the test case description data to generate at least one test suite conforming to a particular format of a test harness;
extracting, at the at least one processor, at least one image of a plurality of images from the test case description data to associate with the test suite, the at least one image identifying a portion of the software application to be tested; and
executing, at the at least one processor, the test harness to test the software application, using the at least one test suite as input to the test harness.

2. The method of claim 1, wherein the test case description data is a test case description data file comprising a plurality of test cases, each of the plurality of test cases comprising one or more steps for testing the software application, wherein each of the plurality of test cases is stored as a table within the test case description data file, and wherein each of the one or more steps comprises a particular image of the plurality of images and corresponding text.

3. The method of claim 1, wherein the test suite comprises a plurality of test cases and wherein extracting at least one image from the test case description data to associate with the test suite comprises adding the at least one image to the test suite.

4. The method of claim 1, further comprising bundling the software application with the test suite.

5. The method of claim 1 further comprising providing for display the output of executing the test harness using the at least one test suite as input.

6. The method of claim 1, wherein parsing the test description data comprises:
identifying at least one section name for at least one table included in the test case description data; and
extracting test case data from a table based on the section name.

7. The method of claim 1, wherein the test harness is the JavaTest harness.

8. A system for test suite generation comprising:
a database;
at least one processor;
an test generation application comprising modules executable by the processor, the modules comprising:
a test description module to:
receive test case description data defining instructions for testing a software application; and
extract at least one image of a plurality of images from the test case description data to associate with the test suite, the at least one image identifying a portion of the software application to be tested;
a test case generation module to parse the test description data to generate the at least one test suite; and
an execution module to test the software application, using the at least one test suite as input to the test harness.

9. The system of claim 8, wherein the test description module is configured to extract at least one image from the test case description data to associate with the test suite by adding the at least one image to the test suite.

10. The system of claim 8, further comprising bundling the software application with the test suite.

11. The system of claim 8, wherein the test case description data is a test case description data file comprising a plurality of test cases each of the plurality of test cases comprising one or more steps for testing the software application, wherein each of the plurality of test cases is stored as a table within the test case description data file and wherein each of the one or more steps comprises a particular image of the plurality of images and corresponding text.

12. The system of claim 8, further comprising providing for display the output of executing the test harness using the at least one test suite as input.

13. The system of claim 8, wherein the test harness is the JavaTest harness.

14. The system of claim 8, wherein the test case generation module is configured to parse the test description data by:
identifying at least one section name for at least one table included in the test case description data; and
extracting test case data from a table based on the section name.

15. A non-transitory computer-readable medium encoded with a test generation application comprising modules executable by a processor, the modules comprising:
a test description module to:
receive test case description data defining instructions for testing a software application; and
extract at least one image of a plurality of images from the test case description data to associate with the test suite, the at least one image identifying a portion of the software application to be tested;
a test case generation module to parse the test description data to generate the at least one test suite; and
an execution module to execute a test harness to test the software application, using the at least one test suite as input to the test harness.

16. The non-transitory computer-readable medium of claim 15, wherein the test description module is configured to extract at least one image from the test case description data to associate with the test suite by adding the at least one image to the test suite.

17. The non-transitory computer-readable medium of claim 15, wherein the test case generation module is further configured to generate text styles to be used for formatting the text of the plurality of test cases.

18. The non-transitory computer-readable medium of claim 15, wherein the test case description data is a test case description data file comprising a plurality of test cases, each of the plurality of test cases comprising one or more steps for testing the software application, wherein each of the plurality of test cases is stored as a table within the test case description data file and wherein each of the one or more steps comprises a particular image of the plurality of images and corresponding text.

19. The non-transitory computer-readable medium of claim 15, further comprising providing for display the output of executing the test harness using the at least one test suite as input.

20. The non-transitory computer-readable medium of claim 15, wherein the test harness is the Java Device Test Suite harness.

21. The non-transitory computer-readable medium of claim 15, wherein the test case generation module is configured to parse the test description data by:
identifying at least one section name for at least one table included in the test case description data; and
extracting test case data from a table based on the section name.
